(19) United States
(12) Patent Application Publication
(10) Pub. No.: US 2020/0072306 A1
(43) Pub. Date: Mar. 5, 2020

(54) BRAKE DISK AND METHOD FOR PRODUCING A BRAKE DISK

(71) Applicant: Ford Global Technologies, LLC, Dearborn, MI (US)

(72) Inventors: Marc Oliver RETTIG, Koln (DE); Jaroslaw GROCHOWICZ, Essen (DE); Tomasz Pawel GRABIEC, Bergisch Gladbach (DE); Clemens Maria VERPOORT, Monheim am Rhein (DE); Andreas WANK, Luckenbach (DE); Alexander HITZEK, Quirnbach (DE); Christian SCHMENGLER, Bendorf (DE); Karin MÜLER-RODEN, Luckenbach (DE); Klaus KAESGEN, Cologne (DE)

(73) Assignee: Ford Global Technologies, LLC, Dearborn, MI (US)

(21) Appl. No.: 16/560,065

(22) Filed: Sep. 4, 2019

(30) Foreign Application Priority Data
Sep. 4, 2018 (DE) 102018215042.7

(51) Int. Cl. F16D 65/12; C09D 5/08

(52) U.S. Cl. CPC F16D 65/12; C09D 5/084; F16D 2065/132; F16D 2200/0013; F16D 2250/0046

(57) ABSTRACT

A brake disk for a wheel brake of a land vehicle includes a main body formed from gray cast iron. The main body has at least one axial friction side, at least one anti-corrosion layer applied to the axial friction side, and at least one anti-abrasion layer applied to the anti-corrosion layer. The anti-corrosion layer is a cost-effective coating for the brake disk that enables enhanced corrosion resistance and is provided as a sherardizing layer. The anti-abrasion layer is wear resistant for the at least one frictional face of the brake disk and is provided by a SiC material containing at least one oxidic or metallic binder, or by an iron-based alloy having a vanadium carbide reinforcement, a niobium carbide reinforcement, a boron carbide reinforcement, a chromium carbide reinforcement or combinations thereof.

### CROSS-REFERENCE TO RELATED APPLICATIONS

This application claims priority to and the benefit of DE 102018215042.7 filed on Sep. 4, 2018. The disclosure of the above application is incorporated herein by reference.

### FIELD

The present disclosure relates to a brake disk for a wheel brake of a land vehicle.

### BACKGROUND

The statements in this section merely provide background information related to the present disclosure and may not constitute prior art.

Conventional brake disks for wheel brakes of land vehicles can be produced using a sand casting method from a low-cost gray cast iron material. The gray cast iron material can be converted to the desired shape with a desired surface finish in the region of the friction ring surface by casting and subsequent turning or grinding.

By virtue of the good thermal conductivity due to graphite flakes in the cast structure, the gray cast iron material is indeed well suited to use in the production of brake disks, but the low hardness of the gray cast iron material, of about 200 HV to about 230 HV, means that it has only limited wear resistance, especially in conjunction with brake linings that are in use on the European market. The friction materials of brake linings contain abrasive substances which provide stable friction coefficients in a wide temperature range. The disadvantage is increased brake disk wear.

In markets outside Europe, motor manufacturers use NAO friction materials (non-asbestos organic friction materials), which cause significantly less wear on the brake disk, although friction coefficients remain stable only up to about 400° C. Abraded particles and fine dust are therefore formed during the braking process. There is ever greater public awareness of fine dust pollution in inner city air caused by road traffic. Moreover, many vehicle customers complain about severe soiling of expensive aluminum rims by encrusted abrasion products from disk brakes.

In addition, a gray cast iron material has very poor corrosion resistance. After just one day of rainy weather, the brake disk is usually rust red if the vehicle is not moved. Only when the rusty surface is subjected to stress and removed by the abrasive action of the brake linings is a metallically clean, visually appealing surface obtained. In the case of hybrid vehicles, however, a brake disk of this kind with a rough rust-red surface is subjected to sufficient mechanical stress only in the case of relatively heavy braking (>0.3·g (g: acceleration due to gravity)). In this case, there can then be brake judder and/or damage to the brake lining and/or unpleasant noise generation.

A very large number of coating solutions for brake disks have therefore been proposed in order to reduce the disadvantages described. A ferritic low-temperature carbonitriding (FNC) method provides temporary corrosion and wear protection. However, this protective effect disappears after only about 10 000 km, i.e., as soon as the thin nitrided zone with a thickness of just 10 μm has been worn away by abrasion. Particularly in the case of linings with a highly abrasive action, as specified by an ECE standard, the coating is removed very quickly. Nevertheless, such temporary protection at moderate cost may be of interest outside Europe when using NAO linings. If, namely, new vehicles are left outside a dealership for a few days in rainy weather, short-term corrosion protection would give a customer for a vehicle with expensive aluminum rims a better visual impression, even if the effect was then to disappear after a few weeks/months.

Moreover, a PSCB (Porsche surface coated brake) brake disk with a chemical nickel corrosion barrier and a WC—Cr₃C₂—Ni top layer formed using a high-velocity flame spraying method (HVOF method), which is supposed to lead to a 90% reduction in fine dust emissions, has come onto the market. However, this very expensive cemented carbide coating cannot be applied for all brake disks worldwide because the strategically important WC material is not available in sufficient quantities.

DE 10 2014 006 064 A1 discloses a gray cast iron brake disk on which various layer systems are used for protection against corrosion and wear. In this case, a fine groove with an undercut is first of all introduced into a friction ring in order to obtain good keying of the subsequently applied thermal spray coating. First of all, a soft NiCr plasma spray coat is then applied, this being intended to stop possible cracks in the hard top layer. However, to ensure that the necessary corrosion protection is also provided and to enable subsurface corrosion of the wear coating to be avoided, the gray cast iron disks are subjected once or twice to a nitriding and oxidizing boundary layer treatment after the introduction of the keying grooves. Subsequently, the adhesion and anti-abrasion layer is then applied by thermal spraying.

Anti-corrosion layers have furthermore been applied by a plasma-powder deposition welding method or a laser deposition welding method. In this case, however, it has been found that the graphite flakes in the gray cast iron material of the brake disks have a disruptive effect in the production of a dense attachment zone. In DE 10 2010 048 075 B4, various methods which allow a surface of gray cast iron brake disks which is free from graphite flakes are presented in relation to optimizing adhesion and reducing subsurface corrosion on gray cast iron brake disks having thermally sprayed anti-abrasion layers by avoiding the access of corrosive media to graphite flakes.

DE 10 2010 052 735 A1 relates to a brake disk having a brake disk main body with at least one friction ring surface coated with a thermal spray layer. Extending over the friction ring surface is at least one depression line, which has an undercut at least on a wall vertical in relation to its base, wherein the undercut depression line provides an adhesion base for the thermal spray layer.

DE 10 2012 022 775 A1 relates to a corrosion-protected composite brake disk which has a brake disk pot and a friction ring, which are joined by means of toothing. The toothing of the friction ring is coated with a zinc-rich coating material and the toothing of the brake disk pot is coated with a zinc-nickel coating.

JP 2005 239 115 A discloses a brake rotor having a rust protection coating produced by hot-dip galvanizing on an outer surface of a fastening flange, which is a fastening surface of the brake rotor.

JP 2009 168 162 A discloses a disk brake rotor having a friction surface which is coated with a phosphate film and is subjected to surface treatment with a strong alkali, thus ensuring a zinc compound on the friction surface.

DE 10 2014 004 616 A1 relates to an anti-abrasion layer comprising an iron-based alloy on the braking surface of a brake disk. The composition has 0.5% to 2% by weight of C, 3% to 13% by weight of Al, and a remaining fraction of trace contaminants typical of steel, to make the total up to 100% by weight.

DE 10 2015 122 325 A1 relates to a brake disk having an outer surface, first and second braking surfaces, which are opposite one another and are bounded in each case by the outer surface, to form opposing first and second braking surface edges, and a plurality of concentric grooves contained on the first braking surface.

The publication retrievable via the link at http://brakedisc.blogspot.com/ discloses a brake disk having a zinc coating for corrosion control.

U.S. Pat. No. 8,006,740 B2 discloses a method for producing a brake rotor which comprises producing a multiplicity of metal insert sections. Each insert section comprises an inside and an outside having a multiplicity of fastening elements which are connected to the inside. The method also encompasses the positioning of the multiplicity of insert sections in a mold, so that the inside of one of the insert sections is facing the inside of another insert section. The method also encompasses the introduction of molten aluminum into the mold, so that the molten aluminum contacts the inside of each insert section. The method further encompasses the formation of a mechanical connection between the aluminum and at least part of at least one of the inserts.

The publication which is retrievable via the link at https://www.sciencedirect.com/science/article/pii/S0924013609-002325 discloses the treatment of an aluminum surface with a pulsating waterjet.

### SUMMARY

The present disclosure provides a low-cost coating for a brake disk which allows improved corrosion and wear resistance for friction surfaces of brake disks having a main body made of gray cast iron.

It should be noted that the features and measures presented individually in the following description can be combined in any technically feasible manner, giving rise to further forms or variations of the present disclosure. The description additionally characterizes and specifies the present disclosure, particularly in conjunction with the figures.

According to the present disclosure, an active zinc corrosion barrier is formed by the anti-corrosion layer or sherardizing layer that is applied to the axial friction side of the brake disk. The anti-corrosion layer is therefore applied by a sherardizing method or a so-called pack diffusion method to the axial friction side and so produced. In the case of the sherardizing method, the brake disks can be heated in a mixture of zinc with silica sand/corundum up to a maximum of 419° C. and more particularly up to the melting point of zinc. In this case, even at temperatures below the melting point of zinc, a zinc vapor is formed which forms a homogenous iron-zinc edge layer on the surface or on the axial friction side of the main body, without formation of hydrogen as in the case of hot-dip galvanizing. Because of the low process temperature, there is no warping of the brake disks.

This decidedly hard, zinc-rich anti-corrosion layer offers desired conditions for applying an anti-abrasion layer thereto without any machining or corundum jet treatment—using a high-velocity flame spraying method (HVOF method), for example. If for this purpose it were to be desired first to implement a blasting treatment on the anti-corrosion layer, the risk would be of local penetration of the thin anti-corrosion layer, with a thickness for example of 50 μm up to a maximum of 100 μm, and consequently it may not be possible to provide the desired corrosion control.

The anti-corrosion layer, at about 40 HRC, has a higher hardness than conventionally hot-dip-galvanized surfaces. The anti-corrosion layer, where appropriate with passivation, may be used, for example, as a low-cost alternative to a coating produced using an FNC method. The anti-corrosion layer does not melt either during the subsequent coating with the anti-abrasion layer or during operation of the wheel brake. That is, ant-corrosion layer is not a melt-metallurgically applied coating.

The anti-corrosion layer of the present disclosure is hard and can be applied to cover the surface of the entire main body, so that there is no seizing and loosening of screws even in the region of the brake hub under the screw forces. As a result, corrosion control is provided permanently even on the contact surface of the brake disk with the wheel hub, and the brake disk surface does not rust on an axle support. Moreover, the anti-corrosion layer of the present disclosure offers effective corrosion control for cooling ribs of a vented brake disk when the anti-corrosion layer is also formed on the cooling ribs. As a result of these measures it is possible to realize a brake disk lifetime of about 240 000 km, with only little wear to the friction surface of the brake disk, and no corrosion to remaining surfaces of the brake disk.

The anti-abrasion layer can be applied to the anti-corrosion layer using a thermal coating method. An example of a thermal coating method that can be employed is the method of high-velocity flame spraying. An exposed surface of the anti-abrasion layer can be ground as a last operation. The anti-corrosion layer may serve as an active cathodic zinc layer which, moreover, serves as a rough keying coating for the subsequent HVOF anti-abrasion layer, meaning that there may be no need for a further jetting/blasting treatment of the anti-corrosion layer.

The main body can be of annular design. The main body can be produced using a sand casting method. The anti-corrosion layer can be applied to the axial friction side in some region or regions or completely. The anti-abrasion layer can be applied to the anti-corrosion layer in some region or regions or completely. The main body can also have two axial friction sides, which are situated axially opposite one another and are correspondingly coated.

The brake disk may be configured as an unvented brake disk or as a vented brake disk with cooling ribs. The brake disk may be annular or plate-like in design.

The land vehicle can be a motor vehicle, in particular a motor car or a commercial vehicle.

According to one advantageous form, the surface of the main body that is joined to the anti-corrosion layer is roughened. The surface of the main body may be roughened, for example, using a high-pressure waterjet method, preferably with pulsating high-pressure waterjets, or by an adapted turning operation, more particularly a turning operation performed dry, or by some other form of machining, in order to be able to produce a defined roughness on the part of the surface. Through the roughening of the surface of the main body it is possible to achieve further increase in the firmness of adhesion of the anti-abrasion layer to the main body. In contrast to the high-pressure waterjet method, for example, a corundum shot method would leave embedded shot particles in the roughened surface of the main body. The high-pressure waterjet method, on the other hand, produces a cleaned surface of the main body, with ideal undercuts and cavitation pockets in the surface of the main body, thereby permitting, for example, effective keying of the HVOF spray particles into the surface to form the anti-abrasion layer. A main body surface roughened and cleaned in this way is suited to subsequent sherardizing for forming the anti-corrosion layer. In that case, the diffusion of zinc into the surface of the main body is not hindered by disruptive corundum particles which have been shot in. In contrast to conventional corundum blasting, therefore, after the high-pressure waterjet method has been carried out, there are no blasting residues present on the surface of the main body that might disrupt the diffusion of zinc into the surface of the main body.

According to another advantageous form, the anti-abrasion layer is produced from a SiC material containing at least one oxidic or metallic binder. The SiC material can be applied using a thermal spraying method, for example, high-velocity flame spraying (HVOF) and/or HVOF with liquid fuel, to the axial friction side of the main body. However, a pure SiC coating powder would decompose during a thermal coating process, for which reason silicon carbides with an approximate size of 1 μm can be surrounded with a casing (binder) of either oxides or metals. This casing material absorbs the heat from an HVOF flame and softens, for example, with the result that, when it strikes the surface, it leads to a dense coating of SiC particles with a casing of oxides or metals. SiC is known for its very high abrasion resistance. SiC furthermore has a high thermal conductivity, which qualifies it for use as an anti-abrasion layer on brake disks. In wear tests, it has been found that a brake disk coated in this way does not exhibit any disk wear. The resulting wear is all the more surprising because hardness measurements show only moderate hardness values with an average of just over 600 HV0.3. Presumably, the SiC particles, which are only 1 μm in size, are virtually undetected during the hardness test, and therefore it is more the hardness of the casing (in this case oxidic) which is measured here. SiC per se has a hardness in a range above 2200 HV0.3.

According to another advantageous form, the anti-abrasion layer is produced from an iron-based alloy having a vanadium carbide reinforcement or a niobium carbide reinforcement or a boron carbide reinforcement or a chromium carbide reinforcement. In this case, the anti-abrasion layer can be produced from a hard iron-based alloy with vanadium carbide as a reinforcing component in a substantially ferritic matrix made corrosion-resistant by alloying with chromium. The vanadium content of a spraying additive can be more than 6% by weight, for example 17% by weight. Hard iron-based alloys of this kind achieve high hardness (approximately 850 HV0.3 in the case of 17% by weight of vanadium—FeCrV17) not by means of a hard matrix but by means of extremely hard vanadium carbides as a reinforcing component. Because the matrix is composed of a ductile iron-based alloy, the composite materials concerned have an extraordinarily high resistance to impact stress and edge stability and are used in many cases to form cutting and knife edges. Niobium as an alloying element in hard iron-based alloys develops an effect comparable with that of vanadium in respect of the precipitation behavior of carbides. As an alternative to hard iron-based alloys containing a high proportion of vanadium, therefore, those with high niobium contents of more than 8% by weight, for example more than 15% by weight, are proposed. FeCrBC hard alloys with chromium contents of at least 17% by weight and boron contents of at least 2% by weight, preferably 25% by weight of chromium and 5% by weight of boron, achieve a hardness of about 900 HV0.3. The hardness of this family of alloys is based on the formation of complex borides and an extremely fine microstructure (often even amorphous to X-radiation). The extremely fine microstructure is also the basis for outstanding resistance to impact stress. Chromium contents of at least 17% by weight (up to 35% by weight) give rise to high corrosion resistance. Alternatively, FeCrC metal-ceramic composite materials consisting of a metallic matrix based on iron with chromium contents of at least 12% by weight, for example 20% by weight to 30% by weight, in order to provide good corrosion resistance, and chromium carbides (preferably Cr₃C₂) with a proportion of at least 50% by weight, for example 75% by weight to 80% by weight, are proposed in order to obtain a high layer hardness (approximately 900 HV0.3 to 1000 HV0.3) and abrasion resistance. In this case, composite powders produced by agglomeration (spray drying) and sintering can be used in order, on the one hand, to have in the layers the particularly hard chromium carbides Cr₃C₂—and not chromium-rich mixed carbides formed from the melt phase, which have an embrittling effect in conventional hard iron-based alloys produced by metallurgical methods involving melting—and in order to avoid embrittling the metallic matrix by enrichment with carbon, which would lower the corrosion resistance and resistance to impact stress. In principle, other hard iron-based alloys can also be used. However, the anti-abrasion materials presented above do not contain elements such as nickel, cobalt, copper and tungsten. The anti-abrasion layers concerned are produced by thermal spraying methods, for example high-velocity flame spraying (HVOF) and/or HVOF with liquid fuel.

In wear tests, it has been found that an HVOF coating composed of FeCrV17 material leads to an excellent wear when paired with conventional brake linings. Thus, there was no wear on the brake disk and no increase in wear on the brake lining material in comparison with the testing of uncoated brake disks. For example, a water-jetted, sherardized main body may be provided with an FeCrV17 anti-abrasion layer about 400 μm thick. The sherardized coating forming the anti-corrosion layer follows the roughened surface of the main body and provides the desired corrosion control. The anti-abrasion layer, composed of an FeCrV17 blade steel, may comprise finely distributed vanadium carbides having an average size of less than 2 μm, which bring about particularly low wear not only on the brake disk but also on conventional brake linings interacting therewith.

The anti-abrasion layers described above therefore consist of low-cost materials which in spite of high hardness are distinguished by corrosion resistance and resistance to stone-chip stressing.

The advantages mentioned above in relation to the brake disk are correspondingly associated with the method. In particular, the brake disk can be produced according to one of the abovementioned forms or a combination of at least two of these forms with one another using the method according to the present disclosure.

The main body can be produced using a sand casting method. The anti-abrasion layer can be applied to the anti-corrosion layer using a thermal coating method, for example a thermal spraying method such as a high-velocity flame spraying method.

According to one form of the present disclosure, the axial friction side is subjected to a machining operation involving turning before the application of the anti-corrosion layer. In particular, the axial friction side can be machined using a dry machining process involving turning and can thereby be smoothed.

According to another form of the present disclosure, the axial friction side is roughened, before the application of the anti-corrosion layer, using a high-pressure waterjet method or by means of machining. The advantages stated above with reference to the corresponding form of the brake disk are associated correspondingly with this form.

According to still another form of the present disclosure, the anti-abrasion layer is applied to the anti-corrosion layer using a high-velocity flame spraying method. This enables rapid production of the anti-abrasion layer.

According to still yet another form of the present disclosure, a surface of the anti-abrasion layer which faces away from the anti-corrosion layer is smoothed. For example, the surface of the anti-abrasion layer can be smoothed by grinding.

In one form of the present disclosure, a brake disk for a wheel brake of a land vehicle includes a main body formed from gray cast iron. The main body has at least one axial friction side, at least one anti-corrosion layer applied to the axial friction side, and at least one anti-abrasion layer applied to the anti-corrosion layer. Also, the anti-corrosion layer is a sherardizing layer, for example, a zinc-rich anti-corrosion layer with a hardness of about 40 HRC. In at least one variation of the present disclosure, the surface of the main body to which the anti-corrosion layer is applied is roughened. In one variation of the present disclosure, the anti-abrasion layer is produced from a SiC material containing at least one oxidic or metallic binder. In such a variation, the SiC material is SiC particles with a particle size of about 1 micrometer (μm). In another variation, the anti-abrasion layer is produced from an iron-based alloy having a vanadium carbide reinforcement, a niobium carbide reinforcement, a boron carbide reinforcement or a chromium carbide reinforcement. In one variation, the anti-abrasion layer is produced from an iron-based alloy with a vanadium content of more than about 6% by weight. In another variation, the anti-abrasion layer is produced from an iron-based alloy with a niobium content of more than about 8% by weight. In still another variation, the anti-abrasion layer is produced from an iron-based alloy with a chromium content of more than about 17% by weight and a boron content of at least 2% by weight. In still yet another variation, the anti-abrasion layer is produced from an iron-based alloy with chromium carbides.

In another form of the present disclosure, a brake disk for a wheel brake of a land vehicle includes a gray cast iron main body with at least one axial friction side, a sherardized zinc-rich anti-corrosion layer on the axial friction side, and an anti-abrasion layer on the anti-corrosion layer. In one variation, the anti-abrasion layer is produced from a SiC material containing at least one oxidic or metallic binder. In another variation, the anti-abrasion layer is produced from an iron-based alloy having a reinforcement selected from at least one of a vanadium carbide reinforcement, a niobium carbide reinforcement, a boron carbide reinforcement, and a chromium carbide reinforcement.

In still another form of the present disclosure, a method for producing a brake disk for a wheel brake of a land vehicle includes applying at least one anti-corrosion layer to at least one axial friction side of a main body produced from gray cast iron and applying at least one anti-abrasion layer to the anti-corrosion layer. Also, the at least one anti-corrosion layer is applied using a sherardizing method. In one variation, the axial friction side is subjected to a machining operation involving turning before applying the anti-corrosion layer. In another variation, the axial friction side is roughened using at least one of a high-pressure waterjet method and a machining method before applying the anti-corrosion layer. In one variation, the anti-abrasion layer is applied to the anti-corrosion layer using high-velocity flame spraying, for example, using high-velocity flame spraying with liquid fuel. In another variation, a surface of the anti-abrasion layer which faces away from the anti-corrosion layer is smoothed.

Although only brake disks have been mentioned above, it is also in accord with the present disclosure to provide drum brakes with the coating. Thus, the inventive concept also includes the method for producing drum brakes with the coating according to the present disclosure (anti-corrosion layer/anti-abrasion layer).

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic axial section through an illustrative form of a brake disk according to the present disclosure; and

FIG. 2 shows a flow diagram of an illustrative form of a method according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

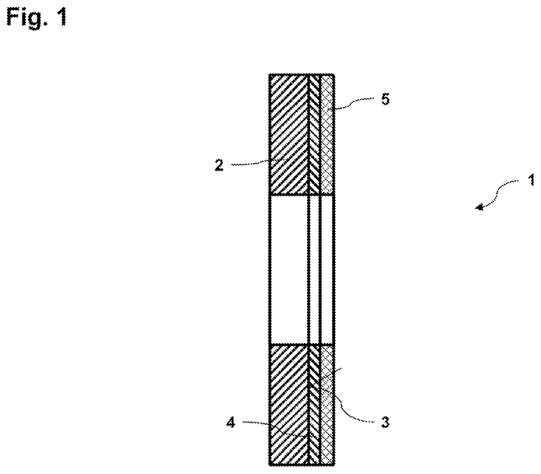

FIG. 1 shows a schematic axial section through an illustrative form of a brake disk 1 according to the present disclosure for a wheel brake (not shown) of a land vehicle (not shown).

The brake disk 1, which is of annular design, has a main body 2 of annular design, formed from gray cast iron, having an axial friction side 3, an anti-corrosion layer 4 of annular design applied to the axial friction side 3, and an anti-abrasion layer 5 of annular design applied to the anti-corrosion layer 4. The anti-corrosion layer 4 is a sherardizing layer. The surface of the axial friction side 3 of the main body 2, connected to the anti-corrosion layer 4, is roughened.

The anti-abrasion layer 5 can be produced from a SiC material containing at least one oxidic or metallic binder. Alternatively, the anti-abrasion layer 5 can be produced from an iron-based alloy having a vanadium carbide reinforcement or a niobium carbide reinforcement or a boron carbide reinforcement or a chromium carbide reinforcement.

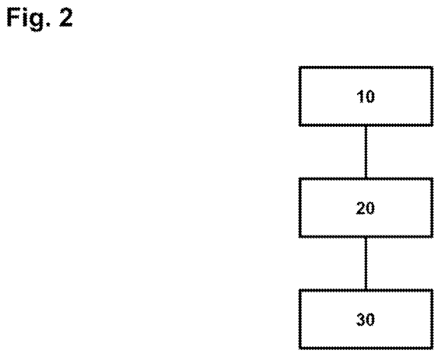

FIG. 2 shows a flow diagram of one illustrative form of a method according to the present disclosure for producing a brake disk for a wheel brake of a land vehicle. The finished brake disk can be configured as shown in FIG. 1.

In step 10, a main body composed of gray cast iron is produced, having at least one axial friction side. For this purpose, a sand casting method can be employed. The axial friction side is first subjected to machining involving turning. After that, the axial friction side is roughened using a high-pressure waterjet method.

In step 20, an anti-corrosion layer is applied using a sherardizing method to the axial friction side of the main body.

In step 30, an anti-abrasion layer is applied to the anti-corrosion layer using a high-velocity flame spraying method. Finally, a surface of the anti-abrasion layer which faces away from the anti-corrosion layer can be smoothed.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A brake disk for a wheel brake of a land vehicle, the brake disk comprising:
a main body formed from gray cast iron and having at least one axial friction side;
at least one anti-corrosion layer applied to the axial friction side, wherein the at least one anti-corrosion layer is a sherardizing layer; and
at least one anti-abrasion layer applied to the anti-corrosion layer.

2. The brake disk according to claim 1, wherein the surface of the main body to which the at least on anti-corrosion layer is applied is roughened.

3. The brake disk according to claim 1, wherein the at least one anti-corrosion layer is a zinc-rich anti-corrosion layer.

4. The brake disk according to claim 3, wherein the at least one anti-corrosion layer has a hardness of about 40 HRC.

5. The brake disk according to claim 1, wherein the at least one anti-abrasion layer is produced from a SiC material containing at least one oxidic or metallic binder.

6. The brake disk according to claim 5, wherein the SiC material is SiC particles with a particle size of about 1 μm.

7. The brake disk according to claim 1, wherein the at least one anti-abrasion layer is produced from an iron-based alloy having a vanadium carbide reinforcement or a niobium carbide reinforcement or a boron carbide reinforcement or a chromium carbide reinforcement.

8. The brake disk according to claim 1, wherein the at least one anti-abrasion layer is produced from an iron-based alloy with a vanadium content of more than about 6% by weight.

9. The brake disk according to claim 1, wherein the at least one anti-abrasion layer is produced from an iron-based alloy with a niobium content of more than about 8% by weight.

10. The brake disk according to claim 1, wherein the at least one anti-abrasion layer is produced from an iron-based alloy with a chromium content of more than about 17% by weight and a boron content of at least 2% by weight.

11. The brake disk according to claim 1, wherein the at least one anti-abrasion layer is produced from an iron-based alloy with chromium carbides.

12. A brake disk for a wheel brake of a land vehicle, the brake disk comprising:
a gray cast iron main body with at least one axial friction side;
a sherardized zinc-rich anti-corrosion layer on the axial friction side; and
an anti-abrasion layer on the anti-corrosion layer.

13. The brake disk according to claim 12, wherein the anti-abrasion layer is produced from a SiC material containing at least one oxidic or metallic binder.

14. The brake disk according to claim 12, wherein the anti-abrasion layer is produced from an iron-based alloy having a reinforcement selected from at least one of a vanadium carbide reinforcement, a niobium carbide reinforcement, a boron carbide reinforcement, and a chromium carbide reinforcement.

15. A method for producing a brake disk for a wheel brake of a land vehicle, the method comprising:
applying an anti-corrosion layer to at least one axial friction side of a main body produced from gray cast iron, wherein the anti-corrosion layer is applied using a sherardizing method; and
applying an anti-abrasion layer to the anti-corrosion layer.

16. The method according to claim 15 further comprising performing, to the axial friction side of the main body, a machining operation involving turning prior to applying the anti-corrosion layer.

17. The method according to claim 15 further comprising roughening the axial friction side using at least one of a high-pressure waterjet method and a machining method prior to applying the anti-corrosion layer.

18. The method according to claim 15, wherein the anti-abrasion layer is applied to the anti-corrosion layer using high-velocity flame spraying.

19. The method according to claim 15 further comprising smoothing a surface of the anti-abrasion layer which faces away from the anti-corrosion layer.

20. The method according to claim 15, wherein the anti-abrasion layer is applied to the anti-corrosion layer using high-velocity flame spraying with liquid fuel.
